(19) United States
(12) Patent Application Publication
(10) Pub. No.: US 2012/0006572 A1
(43) Pub. Date: Jan. 12, 2012

(54) STADIUM GROOMER

(76) Inventors: ROZANNE E. ADAMS, Joseph, OR (US); Alan Dale, Joseph, OR (US)

(21) Appl. No.: 13/174,076

(22) Filed: Jun. 30, 2011

Related U.S. Application Data
(60) Provisional application No. 61/344,363, filed on Jul. 6, 2010.

(51) Int. Cl. A01B 51/00; A01B 35/20; A01B 63/16

(52) U.S. Cl. 172/274; 172/395; 172/611

(57) ABSTRACT

The stadium groomer includes a hitch adapted to be pulled by a vehicle. An adjustable hitching mechanism is disposed on one side of the hitch. The hitch includes a base having wheels disposed at the bottom of the base. A grooming frame is pivotally mounted to the opposite side of the base. The grooming frame includes a tank that can be selectively filled with water to increase the weight of the grooming frame. A plurality of plow blades are disposed on opposite sides of the tank in a relatively staggered pattern, and the penetration depth of each of the blades Is adjustable. An adjustable base leveling bar and a pivotal smoothing bar are mounted to the tank on the trailing side thereof. The leveling bar levels the plowed soil beneath the penetration depth of the plow blades while the smoothing bar smoothes the disturbed surface.

### CROSS-REFERENCE TO RELATED APPLICATION

This application claims the benefit of U.S. Provisional Patent Application Ser. No. 61/344,363, filed Jul. 6, 2010.

### BACKGROUND OF THE INVENTION

1. Field of the Invention

The present invention relates to landscaping devices, and more particularly to a stadium groomer for conditioning stadium grounds to provide a safe and optimum surface for equestrian sports.

2. Description of the Related Art

Many competitive sports or competitions require a specific environment to best judge the performance of the contestants. This applies to both human and animal events. One of the most important considerations is safety for all the participants. Besides the equipment one may wear in the competition, the locale or stadium must also be rendered as safe and ideal as possible for all involved. This is especially significant in equestrian sports, such as reining, where the horse and rider must trod their way through a precise pattern of circles, spins, and stops. Such maneuvers create many opportunities where the horse, as well as the rider, may accidentally injure themselves if the ground has imperfections. Problems with the surface of the ground may result in injuries that can maim the horse. Leg injuries are understandably of major concern to the owners and sponsors because the horses represent a major financial and time investment.

Just as it is important to periodically resurface a skating rink for skating events, similar precautions must be exercised in the equestrian stadium. In that regard, grooming devices have been proposed to loosen and level the stadium ground or arena. A typical grooming device usually comprises a wheeled hitch upon which a plurality of soil loosening blades is mounted. A smoothing bar mounted to the hitch typically trails after the blades to level and flatten the ground surface. While functional, these devices tend to be heavy and unwieldy for a user to maneuver for installation and storage. Moreover, the blades are usually configured to make aggressive cuts into the soil so that the hitch tends to bounce too often as the hitch travels over ground, which can lead to irregularities in the groomed surface. Thus, it would be a benefit in the art of landscaping devices to provide a groomer that is easy to install and setup, and that conditions the ground to have a more uniformly level and cushioned surface.

Thus, a stadium groomer solving the aforementioned problems is desired.

### SUMMARY OF THE INVENTION

The stadium groomer includes a hitch adapted to be pulled by a vehicle. An adjustable hitching mechanism is disposed on one side of the hitch. The hitch includes a base having wheels disposed at the bottom thereof. A grooming frame is pivotally mounted to the opposite side of the base. The grooming frame includes a tank that can be selectively filled with water to increase the weight of the grooming frame. A plurality of plow blades are disposed on opposite sides of the tank in a relatively staggered pattern, and the penetration depth of each of the blades is adjustable. An adjustable leveling bar and a pivotal smoothing bar are mounted to the tank on the trailing side thereof. The leveling bar levels the plowed soil, while the smoothing bar smoothes the disturbed surface. A level locking bar is pivotally mounted to the base to lock the grooming frame in the unfolded, working position.

These and other features of the present invention will become readily apparent upon further review of the following specification and drawings.

### BRIEF DESCRIPTION OF THE DRAWINGS

FIG. 1 is an environmental, perspective view of a stadium groomer according to the present invention.

FIG. 2 is a perspective view of the stadium groomer of FIG. 1 in the unfolded, working position.

FIG. 3 is a perspective view of the stadium groomer of FIG. 1 in the folded, non-working position.

FIG. 4 is a rear perspective of the stadium groomer of FIG. 1.

FIG. 5 is a schematic side view of the stadium groomer of FIG. 1, showing the relative positions of the bars and the corresponding effect on the ground.

Similar reference characters denote corresponding features consistently throughout the attached drawings.

### DETAILED DESCRIPTION OF THE PREFERRED EMBODIMENTS

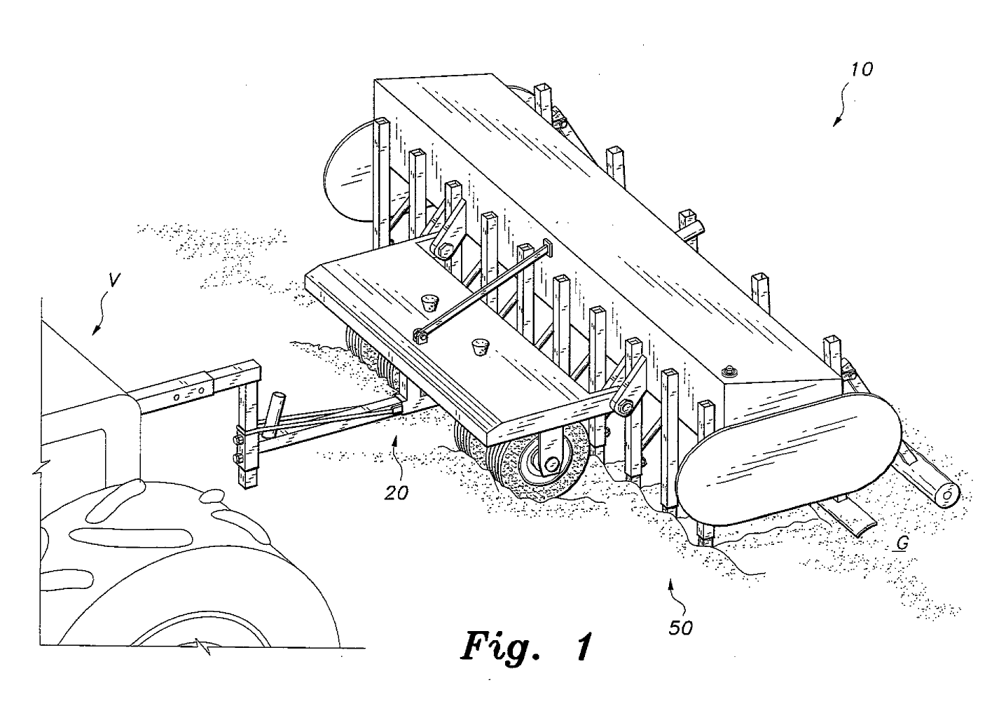

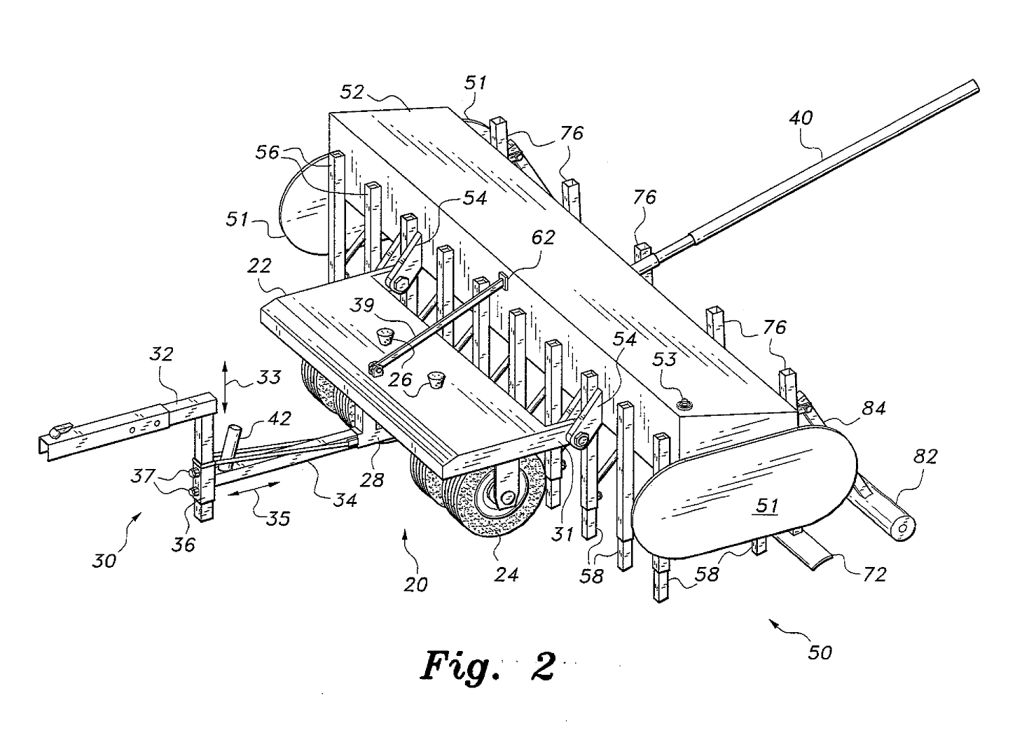

The present invention relates to a stadium groomer, generally referred to in the drawings by the reference number 10, which is configured to provide ease of installation and uniform conditioning of the stadium grounds. Although the following description is specific to an equestrian stadium, it is to be understood that the stadium groomer 10 may be used in any environment where loosening and leveling of the soil may be required. As shown in FIGS. 1 and 2, the stadium groomer 10 includes a hitch 20 and a grooming assembly 50 pivotally mounted to the hitch 20. The stadium groomer 10 is adapted to be pulled by a vehicle V, such as an ATV (all terrain vehicle) or a tractor, via the hitch 20. The grooming assembly 50 includes all the apparatus for conditioning the ground or soil G.

The hitch 20 includes a base 22 with wheels 24 mounted to the bottom of the base 20. The base 22 may be a substantially flat, rectangular platform having a hitching assembly 30 disposed on the leading side and a pair of integral mounting arms 31 extending from the trailing side. The mounting arms 31 facilitate pivotal mounting of the grooming assembly 50, which will be further detailed below. The bottom of the base 20 also includes a mounting bracket or sleeve 28 for the hitching assembly 30. The mounting bracket 28 may be made from hollow, square tubes, to which the hitching assembly 30 is adjustably mounted and set.

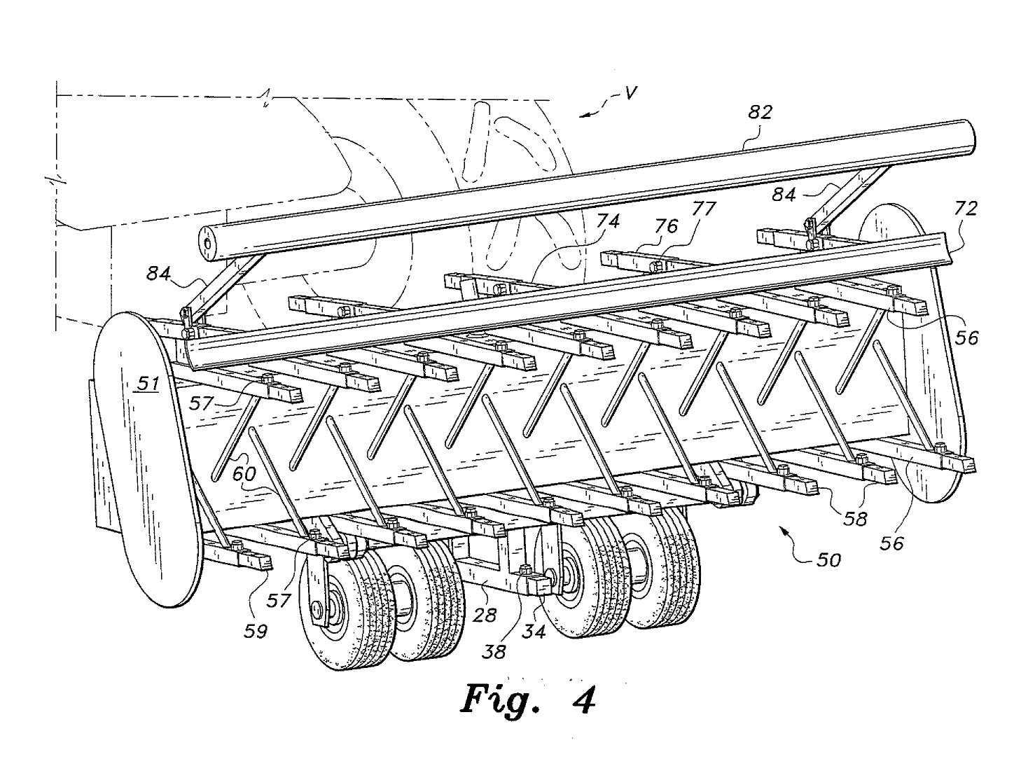

As shown in FIGS. 1, 2 and 4, the hitching assembly 30 includes an extension beam or bar 34 adjustably mounted (frontward and rearward) to the mounting bracket 28, as indicated by the arrow 35. The extension beam 34 sets the desired horizontal position of the base 22, and once adjusted, the position is set by a clamping bolt 38 (shown in FIG. 4). Other clamping or fastening means, such as locking pins or friction clamps, may also be used. This applies to other clamping bolts described herein. The hitching assembly 30 also includes an L-shaped hitching beam or bar 32 adjustably mounted to the leading end of the extension beam 34. One leg of the hitching beam 32 is slidably disposed in a vertical mounting sleeve 36 connected to the extension beam 34, while the other leg includes the connector to the vehicle V. The vertical leg permits vertical adjustment of the hitching beam 32, as indicated by arrow 33, and the adjusted vertical position is set by clamping bolts 37.

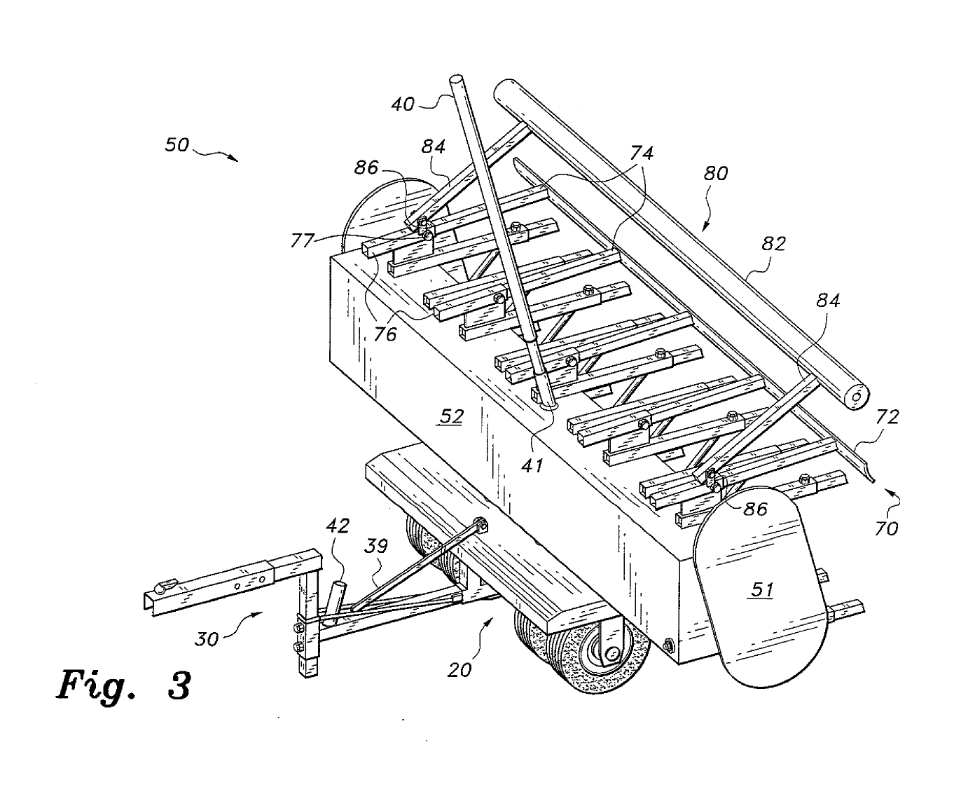

As shown in FIGS. 1-5, the grooming assembly 50 is pivotally mounted to the base 22 via mounting brackets 54 disposed on a tank 52. This permits the grooming assembly 50 to be folded into the stowed position shown in FIGS. 3 and 4, and to be unfolded to the working position shown in FIGS. 1, 2 and 5. The folded position of the grooming assembly 50 results in a compact form, which permits easy maneuvering and handling of the stadium groomer 10 for installation on the vehicle V or storage. To further assist the user, the stadium groomer 10 includes an elongate handling bar 40 that can be mounted in either a first mounting socket 41 (disposed on the tank 52) or a second mounting socket 42 disposed on the extension beam 34). The first mounting socket 41 may be disposed on the trailing side of the tank 52, and the handling bar 40 can be used to assist the user in unfolding the grooming assembly 50 from the base 22. The second mounting socket 42 may be disposed on the extension beam 34, and the handling bar 40 can be used to tilt the stadium groomer 10 for carting the stadium groomer 10 to a desired location. A pair of cushioned stoppers 26 may be disposed on the top of the base 22 to resiliently support the grooming assembly 50 in the folded position.

Due to the pivotal connection between the base 22 and the grooming assembly 50, the grooming assembly 50 may experience excessive bounce during operation thereof, which can lead to uneven grooming of the ground G. To prevent this undesirable result, the stadium groomer 10 includes a level locking bar 39, which maintains the grooming assembly 50 at a desired level with respect to the ground G and prevents the same from folding during operation. The level locking bar 39 is pivotally mounted to the base 22 at one end, and the opposite free end is insertably mounted to a bracket 62 disposed on the leading side of the tank 52. The bracket 62 includes a hole that securely receives the free end of the locking bar 39. When not needed, the level locking bar 39 may be folded away from or towards the base 22 to a stowed position.

As a further preventive measure to bouncing, the grooming assembly 50 includes the tank or housing 52. The tank 52 is preferably a rectangular box to which various ground-grooming features are mounted. The tank 52 may be any elongate shape. At times, the weight of the grooming assembly 50 may not be sufficient to keep the grooming assembly 50 stable and level during operation. In order to add ballast or weight, the tank 52 includes a cap 53 where a desired amount of water may be introduced into the tank 52. Once finished, the grooming assembly 50 can be tilted towards the stowed position and the cap 53 released to flush the water out. The tank 52 also includes skids 51 disposed on opposite ends of the tank 52. The skids 51 may be oblong-shaped plates mounted at an angle. The skids 51 provide a riding or sliding surface for the grooming assembly 50 during operation.

As previously mentioned, the grooming assembly 50 includes the apparatus for conditioning the ground G. Conditioning provides a level and cushioned surface for horses to perform their feats and substantially reduces chances of injury. In the order of work being performed, the grooming assembly 50 includes features for plowing, leveling and smoothing the ground G.

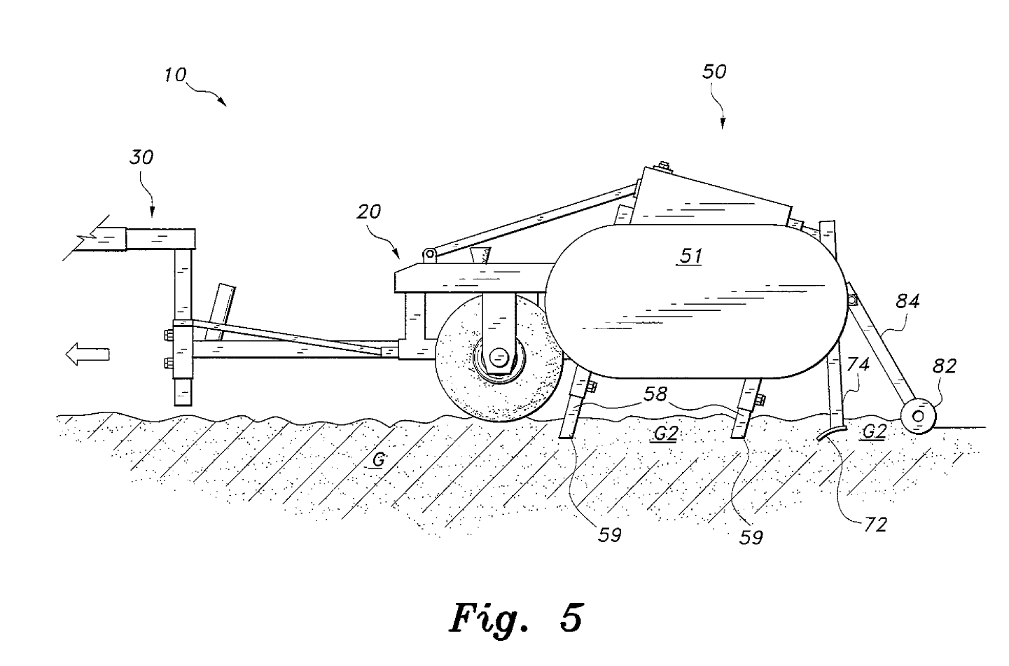

For plowing, the grooming assembly 50 includes a plurality of plowing blades, teeth or bars 58 disposed on the leading and trailing sides of the tank 52. The plowing helps to soften the ground and provide a cushioned surface for the horses. The plowing blades 58 are preferably elongate, rectangular bars of steel where the operative end has been cut to have a beveled edge 59, as shown in FIG. 5. The beveled edge 59 is preferably angled about 22° to 30° from horizontal. This configuration results in a leading cutting edge and a heel section that will be level or angled above with respect to the ground G as the grooming assembly 50 travels over the ground G. As the plowing blades 58 dig through the ground, the blades 58 will experience minimal to no interference from the heel section, which results in a smoother and more stable plowing operation that helps to reduce bounce.

Each plowing blade 58 is adjustably mounted within respective mounting sleeves 56 by clamping bolts 57. The adjustment sets the desired penetration depth of the plowing blades 58. Due to the excessive forces that the plowing blades 58 experience in operation, the top portion of the mounting sleeves 56 are welded to the tank 52 while the bottom portion is braced by a respective bracing arm 60, as shown in FIG. 4. In the embodiment shown in the drawings, the mounting sleeves 56 and the plowing blades 58 are arranged in two rows, with one row being staggered in spacing from the other row. This maximizes the given width of ground G being plowed by the blades 58.

For leveling, the grooming assembly 50 includes a soil leveling assembly 70 disposed adjacent the trailing row of plowing blades 58. The soil leveling assembly 70 evenly levels the loosened or plowed earth behind the plowing blades 58. The level surface is ideal for horses performing the sliding-stop maneuvers with minimal bodily concerns. The soil leveling assembly 70 includes an elongate, base leveling bar 72 adjustably mounted to mounting sleeve brackets 76 by clamping bolts 77. The base leveling bar 72 is disposed parallel to the rows of the plowing blades 58 to thereby affect the whole width of the disturbed soil. The base leveling bar 72 is preferably a curved, flat blade, which has a geodynamic shape to ease travel along the plowed soil, The soil leveling assembly 70 includes a plurality of adjustment bars or beams 74 spaced along the length of the leveling bar 72, each adjustment bar 74 being adapted for mounting within the respective mounting sleeve brackets 76. This adjustment sets the desired depth of the base leveling bar 72. Each mounting sleeve bracket 76 may be attached to one of the mounting sleeves 56 on the trailing side of the tank 52, or anywhere along the length of the tank 52, so long as the base leveling bar 72 is disposed behind the trailing row of plowing blades 58,

For smoothing, the grooming assembly 50 includes a soil smoothing assembly 80 (shown in FIG. 3). The soil smoothing assembly 80 includes an elongate, smoothing bar 82 pivotally mounted to the mounting sleeve brackets 76. A pair of mounting arms, beams or bars 84 extends from opposite sections of the smoothing bar 80 to pivotally mount the smoothing bar 82 via the attachment bracket 86. The smoothing bar 80 is preferably a solid round bar with sufficient weight to stay on the ground G during operation. While the curved surface of the bar 80 allows for reduced frictional engagement with the ground, other geometric shapes may also be employed. The smoothing assembly 80 helps to pack and smooth the earth that has been plowed and leveled. Since the smoothing bar 80 is freely pivotal, the smoothing bar 80 can follow the contours of the worked soil with relative ease.

The following describes how to use the stadium groomer 10. In preparation for use, the user maneuvers and attaches the hitch 20 to a vehicle V with the assistance of the handling bar 40. Then, the user sets the desired depth of each of the plowing blades 58 and the base leveling bar 72 while the grooming assembly 50 is in the folded position. This position renders easy access to the clamping bolts. Once set, the user unfolds the grooming assembly 50 with the assistance of the handling bar 40 and the first socket 41. The level locking bar 39 is installed in the bracket 62 to help maintain the desired level of the grooming assembly 50, and the smoothing bar 82 is unfolded so that the smoothing bar 82 trails the base leveling bar 72. If additional weight is required, the user may fill the tank 52 with water. Then the stadium groomer 10 is pulled by the vehicle V to commence the grooming operation.

As shown in FIG. 5, the grooming operation plows the ground G by the leading and trailing rows of plowing blades 58. The adjacent base leveling bar 72 levels the loosened earth or ground G2 at or slightly below the penetration depth of the plowing blades 58 in order to ensure that the ruts formed by the plowing blades 58 are leveled. Preferably, the base leveling bar 72 extends below the depth of the plowing blades 58 for optimum leveling. The worked earth G2 is then smoothed by the smoothing bar 82.

Thus, it can be seen that the stadium groomer 10 is a convenient device for conditioning the ground. The adjustable hitching assembly 20 allows the stadium groomer 10 to be installed in a wide range of vehicles and conditions, and the pivotal grooming assembly 50 allows the stadium groomer 10 to be folded into an easier compact and transportable form. Moreover, the grooming assembly 10 includes the necessary features to soften, level and smooth the ground for safe exhibition of equestrian sports.

It is to be understood that the stadium groomer 10 encompasses a variety of alternatives. For example, the stadium groomer 10 is preferably made from steel, but other strong, durable materials such as plastics and composites may also be used. The stadium groomer 10 may be made in a variety of sizes, and the specific number and arrangement of plowing blades 58 may be changed accordingly.

It is to be understood that the present invention is not limited to the embodiments described above, but encompasses any and all embodiments within the scope of the following claims.

We claim:

1. A stadium groomer, comprising:
a hitch having a movable base and an adjustable hitching assembly extending from one side of the base, the hitching assembly being adapted for mounting the movable base to a vehicle to be pulled thereby;
a grooming assembly having means for plowing the ground, means for leveling the ground, and means for smoothing the ground as the base is pulled along the ground, the grooming assembly being pivotally mounted to the base opposite the hitching assembly, the grooming assembly being selectively pivotal between a folded, stowed position and an unfolded, working position; and
a level locking bar for locking the grooming assembly at a desired level with respect to the ground, the level locking bar having a first end pivotally mounted to the base and an opposite second end received on the grooming assembly to lock the level.

2. The stadium groomer according to claim 1, wherein said base comprises a top, a bottom, opposing sides, and a mounting bracket disposed on the bottom of said base.

3. The stadium groomer according to claim 2, wherein said hitch comprises wheels mounted to the bottom of said movable base and a pair of integral mounting arms extending from the sides of said base, said grooming assembly being detachably mounted to the mounting arms.

4. The stadium groomer according to claim 2, wherein said hitching assembly comprises:
an extension beam slidably and adjustably mounted to said mounting bracket, the extension beam adjustably setting a desired horizontal position of said base, the extension beam having a vertical mounting sleeve;
a fastener for selectively fastening the extension beam onto said mounting bracket, the fastener fixing the position of the extension beam;
a hitching beam slidably mounted in the mounting sleeve, the hitching beam having a first portion having a connector for mounting the hitching beam to a vehicle and a second portion mounted in the mounting sleeve, the second portion adjustably setting the hitching beam to a desired height; and
a fastener connecting the hitching beam to the mounting beam, the fastener fixing the desired height of the hitching beam.

5. The stadium groomer according to claim 1, wherein said grooming assembly comprises:
a hollow tank, the hollow tank being adapted for bring selectively filled with liquid to increase weight, the tank having a leading side and a trailing side;
a cap disposed on the hollow tank, the cap selectively sealing a hole in on the tank to facilitate filling the tank; and
at least two skids mounted to the tank, the at least two skids supporting the tank and providing a sliding surface for said grooming assembly during operation.

6. The stadium groomer according to claim 5, wherein said means for plowing the ground comprises a row of elongate plowing blades adjustably mounted on the leading side of said tank and a row of elongate plowing blades adjustably mounted on the trailing side of said tank, each of the plowing blades having an operative end and a beveled edge disposed on the operative end.

7. The stadium groomer according to claim 6, wherein said beveled edge is disposed at an acute angle with respect to horizontal during operation of the stadium groomer in order to form a leading cutting edge and a heel section substantially level with the ground for smooth and stable plowing operation and minimal bounce.

8. The stadium groomer according to claim 6, further comprising a plurality of mounting sleeves disposed on the leading side of said tank and a plurality of mounting sleeves disposed on the trailing side of said tank, the row of mounting sleeves on the trailing side being offset with respect to the row of mounting sleeves on the leading side, each of said plowing blades being slidably disposed in a corresponding one of the mounting sleeves, the stadium groomer further comprising a clamping fastener on each of the mounting sleeves to fix each said plowing blade to a desired penetration depth.

9. The stadium groomer according to claim 6, wherein said means for leveling the ground comprises an elongate leveling bar adjustably mounted to said tank, the leveling bar being adjacent to and parallel to said trailing row of plowing blades, the leveling bar trailing said trailing row of plowing blades to level disturbed soil and ruts from said row of plowing blades.

10. The stadium groomer according to claim 9, wherein said leveling bar comprises an elongate, curved, flat blade.

11. The stadium groomer according to claim 9, further comprising:
a plurality of spaced adjustment bars disposed along the length of said leveling bar and a plurality of mounting sleeve brackets disposed on the trailing side of said tank, the plurality of adjustment bars being slidably received in the plurality of mounting sleeve brackets; and
a clamp fastener for each mounting sleeve bracket, the clamp fastener setting the leveling bar at a desired depth for leveling disturbed soil and ruts.

12. The stadium groomer according to claim 11, wherein said means for smoothing the ground comprises an elongate smoothing bar pivotally mounted to said mounting sleeve brackets, the smoothing bar trailing the leveling bar, the smoothing bar smoothing soil leveled by said leveling bar.

13. The stadium groomer according to claim 12, wherein said smoothing bar comprises a solid round bar, the round bar having a weight keeping the round bar on the ground during operation of the stadium groomer.

14. The stadium groomer according to claim 13, further comprising at least one mounting arm extending from said round bar, the at least one mounting arm being pivotally attached to said mounting sleeve brackets to freely pivot thereon.

15. The stadium groomer according to claim 1, further comprising a handling bar selectively mounted to the grooming assembly for assisting unfolding of the grooming assembly and selectively mounted to the hitching assembly to tilt and transport the stadium groomer to a desired location.

16. A vehicle for grooming a stadium comprising:
a mounting hitch on a back side of the vehicle; and
a stadium groomer selectively mounted to the hitch, the stadium groomer having;
a hitch having a movable base and an adjustable hitching assembly extending from one side of the base, the hitching assembly being adapted for mounting the movable base to the mounting hitch on the vehicle to be pulled thereby;
a grooming assembly having means for plowing the ground, means for leveling the ground, and means for smoothing the ground as the base is pulled along the ground, the grooming assembly being pivotally mounted to the base opposite the hitching assembly, the grooming assembly being selectively pivotal between a folded, stowed position and an unfolded, working position; and
a level locking bar for locking the grooming assembly at a desired level with respect to the ground, the level locking bar having a first end pivotally mounted to the base and an opposite second end received on the grooming assembly to lock the level.

17. The stadium groomer according to claim 16, further comprising a handling bar selectively mounted to the grooming assembly for assisting unfolding of the grooming assembly and selectively mounted to the hitching assembly to tilt and transport the stadium groomer to a desired location.
